(19) United States
(12) Patent Application Publication
(10) Pub. No.: US 2015/0211677 A1
(43) Pub. Date: Jul. 30, 2015

(54) Charging Device Holder

(71) Applicant: Mark Patrick Driscoll, Strongsville, OH (US)

(72) Inventor: Mark Patrick Driscoll, Strongsville, OH (US)

(21) Appl. No.: 14/162,999

(22) Filed: Jan. 24, 2014

(51) Int. Cl. F16M 13/02

(52) U.S. Cl. CPC F16M 13/02

(57) ABSTRACT

The invention claimed in this patent is an accessory for charging devices, such as cellular phones, that can plug into electrical outlets with non-conductive prongs shaped like a plug for the purpose of supporting, organizing and protecting the devices while they charge by providing close access to the second electrical receptacle at the outlet. The unit comprises a supportive horizontal and vertical surface joined to the non-conductive prongs to retain the devices against the wall near an electrical outlet.

U.S. PATENT DOCUMENTS

| | | |
|---|---|---|
| D560,115S | January 2008 | Peyridieu et al. |
| D608,356S | January 2010 | Peyridieu et al. |
| D608,357S | January 2010 | Peyridieu et al. |
| 6,969,803 B1 | November 2005 | Friedberg |
| 5,825,874 | October 1998 | Humphreys et al. |
| 5,708,705 | January 1998 | Yamashita et al. |
| 5,539,821 | July 1996 | Blonder |
| 5,075,615 | December 1991 | Dantis |
| D664,529 | November 2011 | Chuang |

### CROSS-REFERENCES TO RELATED APPLICATIONS

This application claims the benefit of the U.S. Provisional Application No. 61/849,302, filed or 371(c) date, Jan. 24, 2013, the disclosure of which is incorporated herein by reference (see APPENDIX).

### Provisional Patent Application

### Name of Applicant: Mark Driscoll

### Title of Invention: Chargeable Device Holder

### application Ser. No. 61/849,302

### Filing or 371(c) Date: Jan. 24, 2013

### STATEMENT REGARDING FEDERALLY SPONSERED RESEARCH OR DEVELOPMENT

Not Applicable.

### MIROFICHE APPENDIX

Not Applicable.

### REFERENCES CITED

### BACKGROUND OF THE INVENTION

1. Field of the Invention

This invention relates to the field of chargeable device accessories. More specifically, the invention comprises a structure for holding and organizing an electric or battery powered device while it charges near an electrical outlet.

2. Description of Related Art

There are many chargeable device accessories that aid in the charging of battery powered electronics devices. Some examples are; desktop holders that prop a device while it charges as it is connected to a computer or structures that loop around plugs and cords to hold a device while they charge at an electrical outlet.

Also, there exists plastic plug child safety protection products that are comprised of plastic prongs which plug into 120V electric receptacles for the purpose of blocking access to the receptacle by a child. This type of product also relates to this invention.

There also exist holders that mount to plug receptacles with conductive prongs (plugs) that hold batteries or charging devices in place while they charge.

Other inventions and products use the plug receptacles as a secure mounting location for the entire product such as night lights and scented room odor products.

### SUMMARY OF THE PRESENT INVENTION

The present invention seeks to provide a means for users of chargeable devices to hold and retain the devices close to the point of charging, the electric outlet receptacle. It also organizes the electric cord used during charging. It can do this by plugging into electric receptacles with non-conductive prongs and providing surfaces for holding and retaining the device which are connected to the secured non-conductive prongs. It can stay mounted in this location for subsequent use at later times without using any cord or plug. It can provide this support for devices of varying sizes by providing the support underneath and orienting the device vertically allowing it to lean against the wall and by not limiting the size of the device used, horizontally or vertically.

### DETAILED DESCRIPTION OF THE PRESENT INVENTION

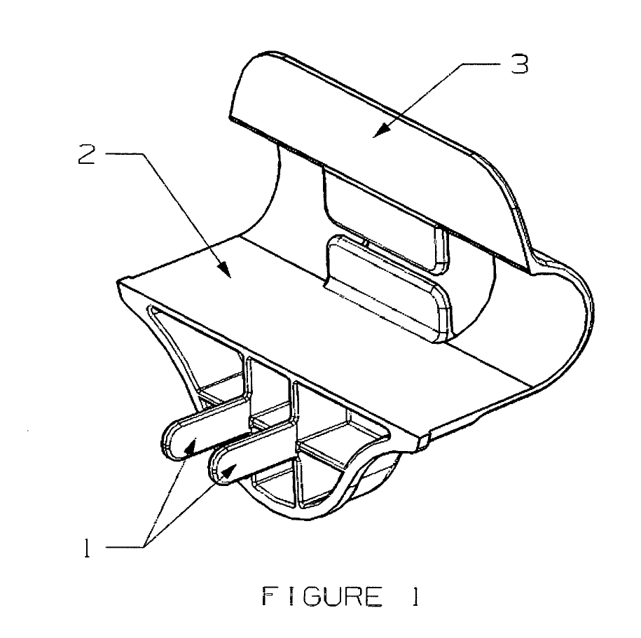

The present invention seeks to provide a useful charging accessory that mounts to an electrical outlet by means of plastic, non-conductive extrusions or prongs (indicated at 1 in FIG. 1) that secure into electric receptacles for the purpose of supporting and organizing a charging device and it's associated parts (cover, cord) and, in doing so, keeping it off of the floor, counter, desk or table, thus keeping the area neater and more organized as well as protecting the devices from potential damage that could occur in a less secure location.

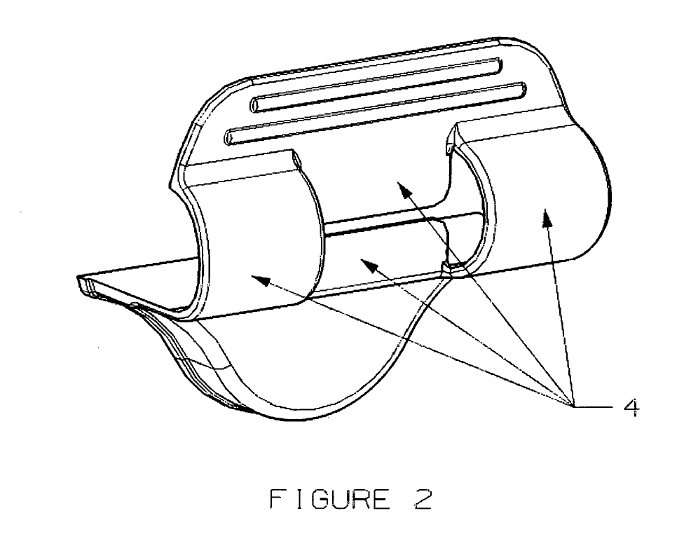

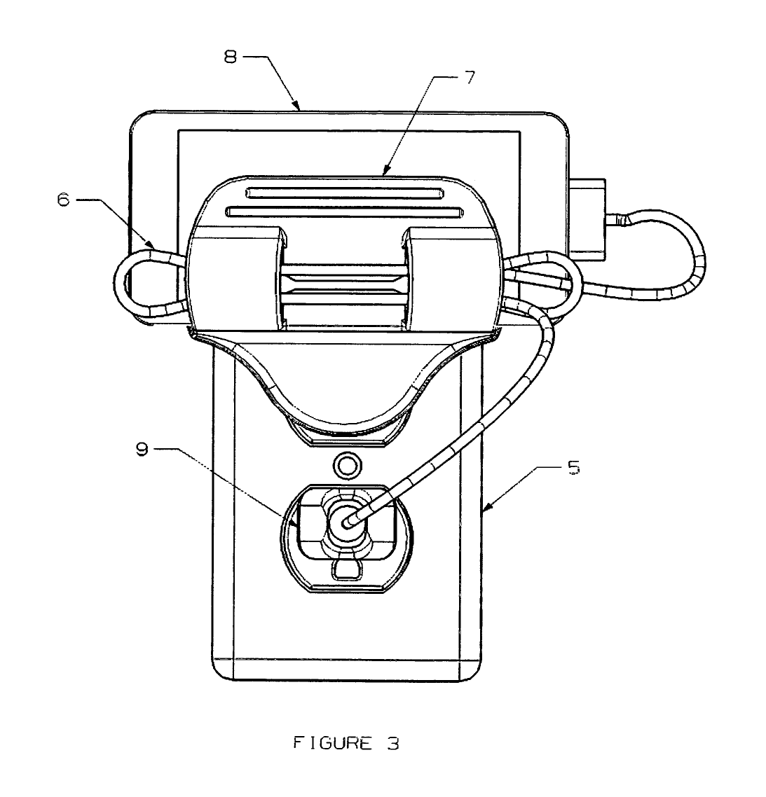

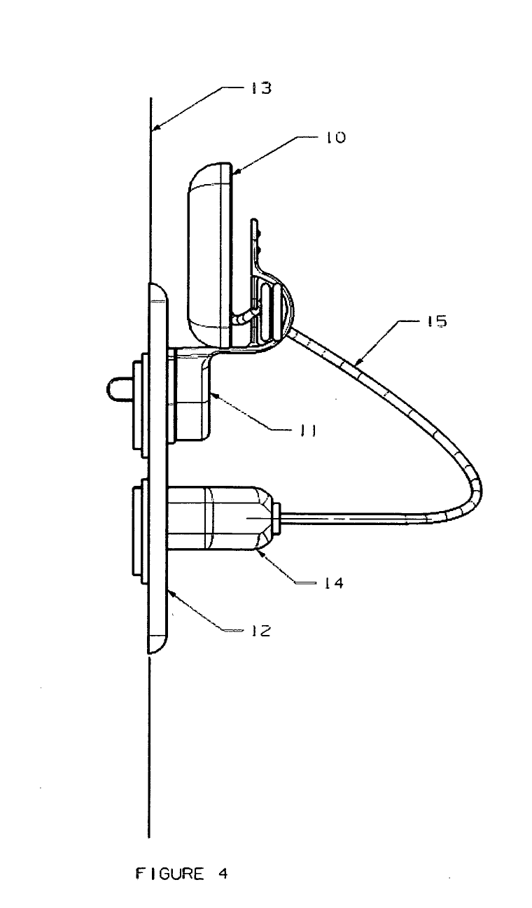

The invention includes a surface to support the device vertically (indicated at 2 in FIG. 1) connected to the plastic extrusions (prongs) that are secured at the receptacle and a vertical surface (indicated at 3 in FIG. 1) to retain the charging device (indicated at 8 in FIG. 3 and at 10 in FIG. 4) horizontally against the wall. It also includes a cord organizer (indicated at 4 in FIG. 2) integrated into the vertical surface to retain the cord (item 6 in FIG. 3 and item 15 in FIG. 4) which is being used for charging the device. This cord would normally be connected to the device and also to the second (lower) receptacle of a typical 120V electric outlet.

The materials used to make this invention are intended to be injection molded plastic such as polypropylene or ABS or polyethylene or any non-conductive material. These are low cost, non-conductive materials that can be formed to the desired shape of the apparatus in an injection molding machine.

The charging device holder is used as follows. When a chargeable device such as a mobile phone requires charging, it is often plugged into a typical household electric outlet with a cord and plug (reference FIGS. 3 and 4). The present invention is plugged into the top receptacle and used as a support for the device and may also be used as an organizer for the cord. The user can then plug the other end of the cord into the bottom receptacle for charging. Likewise, this invention can be designed to plug into the lower of 2 receptacles to provide access to the upper receptacle.

### BRIEF DESCRIPTION OF THE SEVERAL VIEWS OF THE DRAWING

FIG. 1: Rear view of the charging device holder
1. Plastic extrusions or prongs
2. Support surface for the device
3. Retaining wall surface to capture the device against the wall

FIG. 2: Front view of the charging device holder
4. Integrated cord retaining and organizing feature

FIG. 3: Front view of charging device holder with related objects as it is intended to be used.
5. Outlet cover of a typical vertical US style 120V outlet
6. Cord connecting a charging device to the electric receptacle shown organized and retained in the charging device holder.
7. Charging device holder shown plugged into the upper of 2 outlets
8. Example of a charging device
9. Plug inserted in the lower of 2 outlets

FIG. 4: Side view of charging device holder with related objects as it is intended to be used.
10. Side view example of a charging device
11. Charging device holder shown plugged into the upper of 2 outlets
12. Side view of outlet cover of a typical vertical US style 120V outlet
13. Wall
14. Side view of plug inserted in the lower of 2 outlets
15. Charging cord

1. An apparatus for holding, protecting and organizing, charging, electrical or battery-powered, devices and other objects near to an electric outlet receptacle, comprising;
a. Non-conductive extrusions or prongs that press securely into electric outlet receptacles (indicated at 1 in FIG. 1);
b. A support and retaining feature for holding the device, and it's charging cord, connected to the non-conductive extrusions (indicated at 2 in FIG. 1).

2. The apparatus of claim 1, 1a and 1b comprising an integrated cord storage and organizing feature (indicated at 4 in FIG. 2).

3. An apparatus of claims 1 and 1a comprising of a support surface to retain the device.

4. The apparatus of claims 1 and 1a comprising of an elastic or rubber band support to hold and secure the device.

5. The apparatus of claims 1 and 1a comprising of a clamp support to hold and secure the device.

6. The apparatus of claim 1 and 1a comprising of a magnetic support to hold and secure the device.
